(19) United States
(12) Patent Application Publication
(10) Pub. No.: US 2007/0068719 A1
(43) Pub. Date: Mar. 29, 2007

(54) Device for changing the original engine sound of a vehicle

(76) Inventor: Hong Yuan Yang, Changhua County (TW)

Correspondence Address: CHARLES E. BAXLEY, ESQ., 90 JOHN STREET, THIRD FLOOR, NEW YORK, NY, 10038, US

(21) Appl. No.: 11/234,933

(22) Filed: Sep. 26, 2005

(51) Int. Cl. B60T 7/16

(52) U.S. Cl. 180/169; 361/690

(57) ABSTRACT

There is disclosed a device for changing an original engine sound from an exhaust pipe of a vehicle such as a car and a motorcycle. The device includes a control module in which various engine sounds from the exhaust pipes of vehicles are recorded. A selection module is connected to the control module. The selection module is installed near the steering wheel or handle of the vehicle. A sensing module is connected to the control module. The sensing module senses the motion of the accelerator of the vehicle. An amplifier is connected to an output terminal of the control module. A speaker is connected to the amplifier. A muffling module is connected to the control module. The muffling module muffles the original engine sound from the exhaust pipe of the vehicle. With the selection module, a user can select one from the various engine sounds. With the muffling module, the user can muffle the original engine sound of the vehicle. The selected engine sound and the signal related to the motion of the accelerator are transmitted to the control module. The selected engine sound is generated in a manner corresponding to the manner the vehicle is driven. The fun in driving the vehicle is increased.

### BACKGROUND OF INVENTION

1. Field of Invention

The present invention relates to a device for changing the original engine sound of a vehicle so that the original engine sound is replaced with another engine sound generated in a manner corresponding to the manner in which the vehicle is maneuvered.

2. Related Prior Art

Various vehicles (or “models”) such as cars, trucks, trailers and motorcycles have been made. For different histories of development and focuses, the vehicles are different regarding their exteriors, interiors, equipment and engine sounds. While selecting vehicles, customers are influenced by these features. However, in fast changing societies, the customers' tastes for vehicles change fast. As vehicles are expensive, the customers cannot afford to change vehicles whenever their tastes for vehicles change. Hence, there have been decorations and substitutes for changing the exteriors or interiors of the vehicles. They satisfy the customers' needs for changes to some degrees. Yet, there seems no way to change the engine sounds of the vehicles except changing the exhaust pipes of the vehicles. Except changing the pitch and volume of the original engine sound, it cannot replace the original engine sound with the engine sound of another vehicle.

In other words, there has not been any disclosure of a device for changing the original engine sound of a vehicle. Hence, the customers' needs for changes and the fun in maneuvering their vehicles will be better satisfied if there is a device for changing the original engine sound of a vehicle.

The present invention is therefore intended to obviate or at least alleviate the problems encountered in prior art.

### SUMMARY OF INVENTION

The primary objective of the present invention to satisfy a user's need for changes and increase the user's fun in maneuvering a vehicle by providing a device for changing the original engine sound of the vehicle.

According to the present invention, a device is provided for changing the original engine sound of a vehicle. The device includes a control module in which engine sounds are recorded. A selection module enables a user to select one from the engine sounds recorded in the control module. A sensing module senses the motion of the accelerator of the vehicle and sends signals to the control module. An amplifier receives signals related to the selected engine sound and the sensed motion of the accelerator from the control module and amplifies the same. A speaker generates the selected engine sound based on the amplified signals related to the selected engine sound and the sensed motion of the accelerator.

Other objects, advantages and novel features of the present invention will become more apparent from the following detailed description referring to the attached drawings.

### BRIEF DESCRIPTION OF DRAWINGS

The present invention will be described via detailed illustration of embodiments referring to the drawings.

FIG. 1 is a block diagram of a device for changing the original engine sound of a vehicle according to the preferred embodiment of the present invention.

FIG. 2 is a perspective view of a car equipped with the device shown in FIG. 1.

FIG. 3 is a side view of the car shown in FIG. 2.

FIG. 4 is a perspective of a motorcycle equipped with the device shown in FIG. 1.

### DETAILED DESCRIPTION OF PREFERRED EMBODIMENT

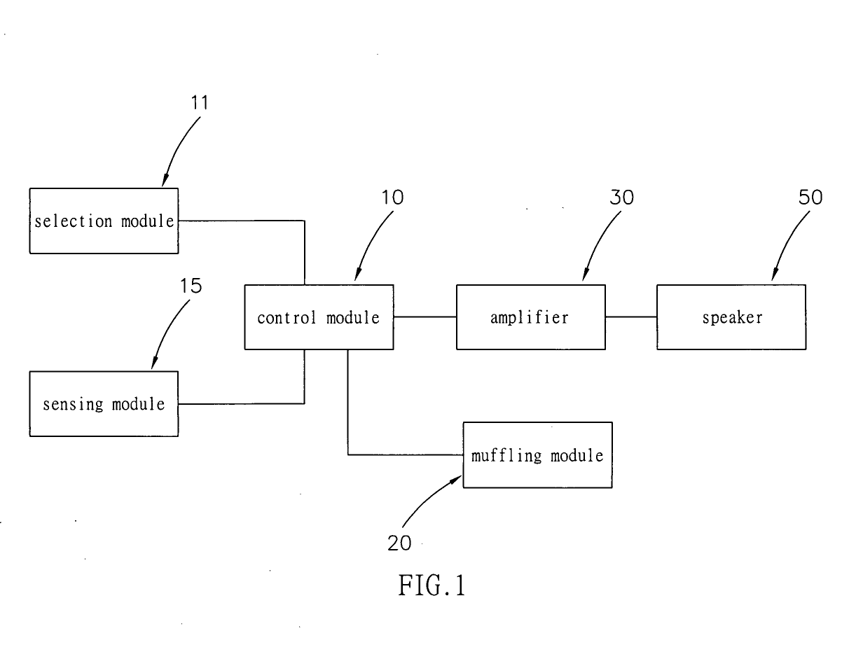

Referring to FIG. 1, there is shown a device for changing the original engine sound of a vehicle. The device includes a control module 10, an amplifier 30 and a speaker 50.

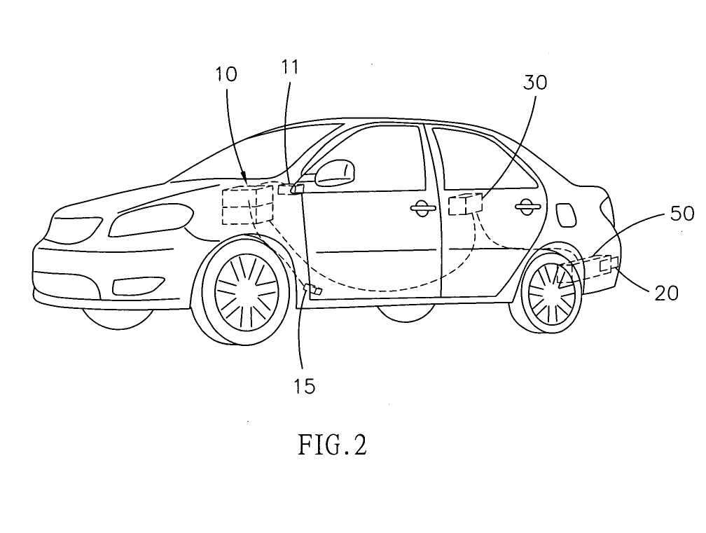

Referring to FIGS. 1 and 2, the control module 10 is connected to or incorporated in the computer of the vehicle. A selection module 11 is connected to the control module 10, and so is a sensing module 15. The selection module 11 is installed near the steering wheel, handle or dashboard of the vehicle. The selection module 11 enables a user to select one from various engine sounds recorded in the control module 10 and select one from various pitches and volumes of the selected engine sound recorded in the control module 10. Signals based on the selects are transmitted to the control module 10. The sensing module 15 senses the motion of the accelerator of the vehicle and sends a signal based on the sensed motion of the accelerator to a microprocessor of the control module 10. The sensing module 15 may be mechanical, electro-optical or magnetic. The transmission of the signal can be done through wires or in a wireless manner. The engine sounds are recorded in the microprocessor of the control module 10.

A muffling module 20 is connected to the control module 10. The muffling module 20 may be a muffler or a device for generating corresponding frequencies.

An output terminal of the control module 10 is connected to the amplifier 30. The signals from the control module 10 are amplified in the amplifier 30.

The speaker 50 is connected to the amplifier 30. A selected engine sound is generated by means of the speaker 50 based on the amplified signals from the amplifier 30.

With the selection module 11, the user can select one from the engine sounds. The control module 10 provides the selected engine sound. The sensing module 15 provides the control module 10 with the signal based on the motion of the accelerator. Through the amplifier 30, from the speaker 50, the selected engine sound is played in a manner based on the manner the user maneuvers the vehicle. When the motion of the accelerator is violent, the selected engine sound is played loud. When the motion of the accelerator is gentle, the selected engine sound is played softly. The fun in driving is increased.

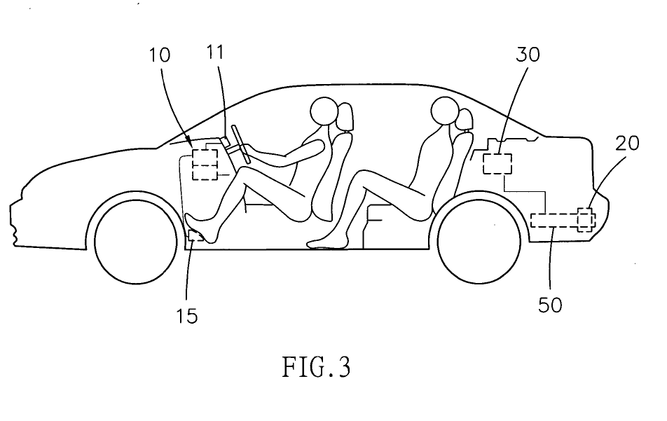

Referring to FIGS. 2 and 3, the device is used in a car. The selection module 11 is installed near the steering wheel of the car. The sensing module 15 is installed near the accelerator (or “gas pedal”) of the car. The muffling module 20 is installed near the exhaust pipe of the car. To change the original engine sound of the car, with the selection module 11, a driver selects one from the engine sounds recorded in the control module 10. On receiving the signal based on the select, the control module 10 sends a signal to the muffling module 20 that muffles the original engine sound. Meanwhile, the control module 10 receives the signal corresponding to the motion of the accelerator from the sensing module 15. Signals related to the selected engine sound and the sensed motion of the accelerator are received and amplified by means of the amplifier 30. Based on the amplified signals, the speaker 50 generates the selected engine sound in a manner corresponding to the manner in which the driver drives the car. The fun in driving is increased.

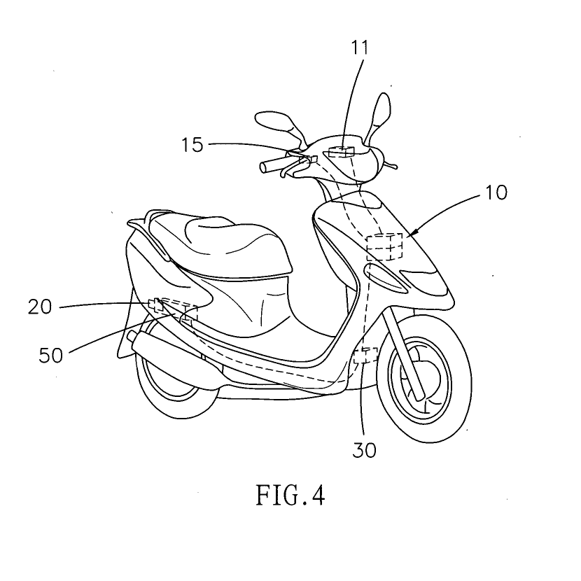

Referring to FIG. 4, the device is used on a motorcycle. The selection module 11 is installed on the dashboard of the motorcycle. The sensing module 15 is installed near the accelerator (generally the right handle) of the motorcycle. The muffling module 20 is installed near the exhaust pipe of the motorcycle. To change the original engine sound of the motorcycle, with the selection module 11, a rider selects one from the engine sounds recorded in the control module 10. On receiving the signal based on the select, the control module 10 sends a signal to the muffling module 20 that muffles the original engine sound. Meanwhile, the control module 10 receives the signal corresponding to the motion of the accelerator from the sensing module 15. Signals related to the selected engine sound and the sensed motion of the accelerator are received and amplified by means of the amplifier 30. Based on the amplified signals, the speaker 50 generates the selected engine sound in a manner corresponding to the manner in which the rider rides the motorcycle. The fun in riding is increased.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A device for changing the original engine sound of a vehicle, the device comprising:
a control module (10) in which engine sounds are recorded;
a selection module (11) for enabling a user to select one from the engine sounds recorded in the control module (10);
a sensing module (15) for sensing the motion of the accelerator of the vehicle and sending a signal to the control module (10);
an amplifier (30) for receiving signals related to the selected engine sound and the sensed motion of the accelerator from the control module (10) and amplifying the same; and
a speaker (50) for generating the selected engine sound based on the amplified signals related to the selected engine sound and the sensed motion of the accelerator.

2. The device according to claim 1 comprising a muffling module (20) for muffling the original engine sound under the control of the control module (10).

3. The device according to claim 2 wherein the muffling module (20) is a muffler.

4. The device according to claim 2 wherein the muffling module (20) is a device for generating corresponding frequencies.

5. The device according to claim 1 wherein it is used in a car.

6. The device according to claim 5 wherein the selection module (11) enables the driver to select one from the engine sounds and to adjust the bass and treble of the selected engine sound.

7. The device according to claim 1 wherein it is used on a motorcycle.

8. The device according to claim 1 wherein the sensing module (15) senses the motion of the accelerator of the vehicle.

9. The device according to claim 1 wherein the sensing module is a mechanical sensor.

10. The device according to claim 1 wherein the sensing module is an electro-optical sensor.

11. The device according to claim 1 wherein the sensing module is a magnetic sensor.

12. The device according to claim 1 wherein the transmission of the signals is done through wires.

13. The device according to claim 1 wherein the transmission of the signals is done in a wireless manner.
